(19) United States
(12) Patent Application Publication
(10) Pub. No.: US 2005/0157865 A1
(43) Pub. Date: Jul. 21, 2005

(54) System and method of managing a wait list queue

(76) Inventors: C. Douglas Yeager, Knoxville, TN (US); Robert O. Knudson IV, Knoxville, TN (US)

Correspondence Address: LUEDEKA, NEELY & GRAHAM, P.C., P O BOX 1871, KNOXVILLE, TN, 37901, US

(21) Appl. No.: 11/038,508

(22) Filed: Jan. 19, 2005

Related U.S. Application Data
(60) Provisional application No. 60/537,986, filed on Jan. 21, 2004.
(60) Provisional application No. 60/565,462, filed on Apr. 26, 2004.
(60) Provisional application No. 60/616,324, filed on Oct. 6, 2004.

(51) Int. Cl. H04M 3/00; H04M 3/42; H04M 5/00

(52) U.S. Cl. 379/266.06; 379/201.04

(57) ABSTRACT

A system for tracking a service request queue. The queue is electronically maintained and the system calculates current estimated wait time and tracks current place in queue. The system also initiates events based upon queue changes. Events include notifying users when service is ready or about ready. One or more radio frequency identification (RFID) label readers are used, and RFID labels are attached to or associates with signaling devices such as a pager or cell phone. A computer calculates queue changes and initiates events. One or more RFID readers are used to provide current queue status and wait time information to users based upon RFID labels that are within the range of the RFID's antenna.

### CROSS REFERENCES TO RELATED APPLICATIONS

This patent application claims priority from and is related to U.S. Provisional Patent Application No. 60/537,986 filed Jan. 21, 2004, entitled “System and Method of Managing a Guest List Wait Queue,” and this patent application claims priority from and is related to U.S. Provisional Patent Application No. 60/565,462 filed Apr. 26, 2004, entitled “System and Method of Managing a Guest List Wait Queue,” and this patent application claims priority from and is related to U.S. Provisional Patent Application No. 60/616,324 filed Oct. 6, 2004, entitled “System and Method of Managing a Guest List Wait Queue.” These U.S. Provisional Patent Applications are incorporated by reference in their entirety herein.

### FIELD

This invention relates to the field of service queues. More particularly, this invention relates to equipment and methods for tracking the status of requests from clients for services from service providers such as restaurants, hospitals, maintenance workers and so forth.

### BACKGROUND

Many service providers receive requests from users for service at a rate faster than the service can be started. An example of this is guests arriving at a restaurant. Typically the identification of users who are asked to wait is placed in a queue, and the users are served from the queue on a first-come-first-served basis. While they are waiting, the users typically desire to know how their position in the queue is changing, and their remaining wait time. Various systems have been developed to attempt to address some of these needs. One system is the “take a number” system. Users take a sequential number from a dispenser, and a central “now serving” index counter is provided. When a new service opportunity becomes available, the service provider calls out the next number after the current index count number, and then increments the index counter.

One general limitation of the “take a number” system is that it requires that all service opportunities be the same. This does not work in situations like restaurants where party sizes and seating area preferences vary. Such a service provider may not be able to next serve the person holding the next number. Consequently, many such service providers maintain a sequential “wait list” of customers as they arrive, and record their service needs such as party size and seating preference. Then, for example, when the appropriate size table becomes available in the requested seating area, an attendant calls out the name of the next party in the queue that meets the available service criteria.

A limitation of both the “take a number” system, and the “wait list” system is that they require that the waiting users remain near the point of service in order to hear when their number or name is called. To overcome this proximity limitation, some service providers issue pagers to guests when they are placed in the queue. When service is available for a customer on the list, the service provider signals that user's pager.

None of these current systems adequately meet all of a customer's needs. Most notably, users are interested in receiving updates on their estimated wait time and their position in the queue. Wait time information is not generally available anywhere in the “take a number” system. With “wait list” and “pager” systems, users typically have go to the attendant who maintains the queue, and the attendant checks the list and estimates the remaining wait time. Such estimates are generally inaccurate and the process is inconvenient for both the service provider and the customer. Furthermore, if delays in service are encountered, waiting customers may become irritated and engage in undesirable behavior at the point of service where new customers are arriving. What is needed is a more effective system and method to keep customers informed of their wait times, to reduce disruption around the point of service where new customers are being accepted, and to otherwise improve the management of a service request queue.

### SUMMARY

With regard to the above, in one of its embodiments the invention provides a system for tracking a service request queue. The system includes an identification tag for issuance to a user and an identification tag writing station for recording queue information on the identification tag. A queue status query station is provided that has (a) an identification tag reader for reading the queue information on the identification tag and (b) a display for displaying queue status information corresponding to the queue information, so that when the identification tag is presented to the queue status query station the queue information is read and the queue status information is displayed. The system also provides an alerting system for generating an alert signal to indicate a change in the service request queue. A signaling device associated with the identification tag is included. The signaling device is responsive to the alert signal to generate a notification signal for notifying the user of a change in the service request queue.

Another embodiment providing a system for tracking a service request queue includes an identification tag that has a stored identification number, for issuance to a user. A service request management processor is provided for maintaining queue information associated with the identification number. The system also includes a queue status query station that has (a) an identification tag reader for reading the identification number of the identification tag, (b) a communication link with the service management processor for communicating queue information associated with the identification number, and (c) a display for displaying queue status information corresponding to the queue information associated with the identification number, so that when the identification tag is presented to the queue status query station, queue status information is displayed The system also includes an alerting system for generating an alert signal to indicate a change in the service request queue; and a signaling device associated with the identification tag. The signaling device is responsive to the alert signal to generate a notification signal for notifying the user of a change in the service request queue.

A further embodiment provides a method of tracking a service request queue. The method begins by associating a signaling device with an identification tag, and proceeds with issuing the identification tag to a user. The method continues with displaying queue status information when the identification tag is presented to a queue status query station, and then notifying the user of a change in the service request queue using the signaling device.

### BRIEF DESCRIPTION OF THE DRAWINGS

Further advantages of the invention are apparent by reference to the detailed description in conjunction with the figures, wherein elements are not to scale so as to more clearly show the details, wherein like reference numbers indicate like elements throughout the several views, and wherein:

FIG. 1 is a block diagram of the invention.

FIG. 2 illustrates the contents of electronic memory used according to the invention.

FIGS. 3A, 3B, and 3C present a flow diagram illustrating a method of the invention.

FIG. 4 is an illustration of a signaling device with an identification tag affixed to it.

FIG. 5 is an illustration of a token with an identification tag affixed to it.

FIG. 6 is an illustration of a service request management processor according to the invention.

FIG. 7 is an illustration of a queue status query station according to the present invention.

FIG. 8 is a perspective illustration viewed from the rear of a system for tracking a service request queue.

FIG. 9 is an illustration of the front side of system for tracking a service request queue according to the invention.

### DETAILED DESCRIPTION

A system and method of managing a wait list queue is provided in the present invention. The wait list queue represents requests from users for services from a service provider. In one embodiment of the invention, the system incorporates radio-frequency identification (RFID) labels that are affixed to pagers that are issued to users, such as guests at a restaurant. The pagers are used to alert the user that their service is ready. In another embodiment of the invention, RFID labels are affixed to a token device such as a paperclip, which is provided to guests who have a cellular telephone (cell phone) and wish to be notified of their service status via the cell phone. RFID labels are an example of an identification tag. Other examples of an identification tag are a bar code label, an optical or magnetic character recognition label, and a magnetic stripe label. An identification tag typically stores an identification number that can be read by electronic means. In preferred embodiments the identification number is a unique sequence number, but in some embodiments the identification number is a product serial number or a unique name or other identifier that is not even a number. Pagers and cell phones are examples of a signaling devices. Other examples of a signaling device are a personal digital assistant or similar wireless communicator, and a wireless watch.

In some embodiments, the system includes a centralized RFID reader and antenna that is used by the service provider. This RFID reader and antenna continuously monitors all RFID labels that are affixed to guest pagers that enter and leave the antenna range as they are issued to and returned by guests. This RFID reader is an example of an identification tag dispenser. Another example of an identification tag dispenser is a barcode scanner that is used when bar code labels are used as identification tags. In some embodiments, a separate RFID reader and antenna is provided to continuously monitors all RFID labels that are affixed to paper clips (or other token devices) that enter and leave the antenna range. In preferred embodiments a single RFID reader is used to read all RFID labels entering and leaving the identification tag dispenser, regardless of whether they are affixed to pagers or tokens.

In the most preferred embodiments, an RFID reader and antenna is also provided for use by guests for the purpose of determining current wait list status. This RFID reader is an example of an identification tag reader and it continuously checks for any RFID label that is affixed to a guest pager or token and that enters that antenna range. A user may determine information about the status of his/her position in the service queue by presenting his/her identification tag to the RFID reader at this queue status query station. When bar codes are used as identification tags, the identification tag reader is a bar code reader; when magnetic stripes are used as identification tags, the identification tag reader is a magnetic stripe reader, and so forth. The identification tag reader typically electronically reads an identification number stored by the identification tag.

Preferred embodiments also incorporate an integrating unit, or service request management processor, that allows an attendant using the guest pager system to interact with the wait list queue management system. The service request management processor may include an identification tag writing station for recording queue information on the identification tags. The service request management processor also may allow the attendant to monitor the status of the service request queue. In most embodiments a computer central processing unit (CPU) is used as the central control element of the service request management processor to manage the overall operation of the system.

In preferred embodiments, when an identification tag is issued to a user through an identification tag dispenser, the attendant is automatically prompted by the service request management processor to record queue information into the memory of the service request management processor and/or onto the identification tag using the identification tag writing station. In preferred embodiments the identification tag dispenser and the identification tag writing station are both part of a single integrating unit (the service request management processor). Examples of queue information that may be written to the service request management processor and/or onto the identification tag are (a) a queue sequence number, (b) date and time of entry into the queue, (c) expected service wait time, (d) and user characteristics, such as the number in the party, seating preference, and so forth. For embodiments that employ an identification tag writing station, much of the queue information is preferably developed and written automatically to the identification tag under the control of a CPU in the service request management processor.

As guest pagers with affixed RFID labels are removed from their centralized monitored location, the RFID label ID is automatically added to the end of an electronic queue. As paper clips (or other tokens) with affixed RFID labels are removed from their monitored location, this RFID label ID is also added to the end of the same electronic queue. In embodiments where the paper clips are removed from a separate RFID reader and antenna, they may be distinguished from the pager removal because a different reader senses the removal. In embodiments where a single RFID reader and antenna is used to monitor both pager RFID labels and paper clip RFID labels, the CPU is programmed to know which RFID labels are associated with pagers and which are associated with paper clips, so that when one is removed the system knows whether it was a pager RFID label or a paper clip RFID label. When paper clips are removed the attendant is prompted for a phone number and an alert time. The attendant may answer the prompt with a touchpad provided on a integrator unit that manages the system.

As either pagers or paper clips are put back into their centralized monitored location, the system automatically updates the queue. As the queue updates itself, various actions may be initiated. The queue may be scanned for any alert times that are less than or equal to the current wait time estimate for each place in the queue. This is an example of a change in the service request queue. If any alert times are past due, the system may notify the guest via phone call and automatically play a message that may contain language like, “Your table will be ready in 10 minutes.” The return of paper clips and pagers to the monitored locations is another example of a change in the service request queue. As paper clips and pagers are returned to the centralized monitored location, if service intake intervals are short, the pager or phone number associated with the next party in the queue may be signaled automatically. In the case where the next party in the queue is the holder of a paper clip RFID label, the associated phone number may be automatically dialed and a pre-recorded message may be played that may contain language like, “Your table is now ready; please see the attendant at the greeter desk.”

The system may additionally provide current total wait time estimates to the service request management processor display as well as provide current wait time estimates to currently waiting guests at the queue status query stations. To provide current wait time estimates at a queue status query station, a communication link is established between the queue status query station and the service request management processor. The communication link may be a wired or wireless computer network, a terminal-server connection, or similar interconnection. Typically identification numbers from identification tags are sent by the queue status query station to the service request management processor, and the service request management processor then sends current queue status information associated with that identification number back to the queue status query station. Thus, when guests would like to inquire about their specific wait list position and wait time, they may place their pager or paper clip that is affixed with an RFID label next to a queue status query station and it displays the current information pertaining to their wait, such as current wait time and current place in wait list queue. Current wait time and current place in wait list queue are examples of queue status information.

In some embodiments of the present invention, wait time data such as a timestamp of the future time to be seated may be written directly to the RFID label that is attached to the pager or paper clip when the pager or paper clip is issued to a user (guest). A timestamp of the future time to be seated is an example of queue information. In some of these embodiments, the queue status query stations may not be connected to the integrator central processing unit (service request management processor) through a communication link, and the queue status query station may simply act as an independent timing unit and or data display unit. Also, this embodiment may forego the monitoring of which RFID labels (that are attached to pagers) have left the pager storage area. Instead, an RFID writing device (identification tag writing station) is used to write pertinent queue information data such as a timestamp of the future time to be seated to the pager RFID label. Then preferably, each queue status query station has a time clock and a small microprocessor that interfaces with the display on the queue status query station. The queue status query station reads RFID tags that are presented to it, subtracts the RFID tag's timestamp of the future time to be seated from the queue status query station time clock's current time, and the queue status query station then displays the time difference. The time difference represents the time left before being seated, and it is an example of queue status information that may be provided to a guest at a queue status query station. A very simple processor is typically used to convert the queue information into the queue status information that is displayed. In some embodiments, the queue information is displayed as queue status information without any processing, calculation, re-formatting, or other manipulation.

Multiple queue status query stations may have their time clocks synched together by connection to a local network or synched together by connection to time servers operated by the National Institute of Standards and Technology (NIST), or periodically manually synched together, or synched together by similar means. A queue status query station that operates independently from the service request management processor, except possibly for synchronization of their time clocks, is referred to as a stand-alone queue status query station.

Also, in some embodiments each queue status query station may be notified of changes in the overall wait expected wait time, and thereby provide a more accurate estimate to users who request queue status information. One way to do this is to artificially change the queue status query station time clocks changed to reflect fluctuations in overall wait time. One method of changing the clocks of one or more queue status query stations simultaneously is to embed one or more pager receiver circuits in each queue status query station. For example, each queue status query station may be outfitted with two pager receiver circuits, one as pager #98 and the other as pager #99. These pager receiver circuits are an example of a delay status receiver. Then, for example, if delay times are extended, the hostess or manager pages pager #98, a page is sent to pager #98 each queue status query station, and each updates their internal clock by decreasing the clock by 5 minutes. Then, when a user presents an RFID tag to the queue status query station to determine expected wait time, an extra five minutes is automatically added because there is five more minutes between the recorded expected seating time and the now artificially slow “current” time. Similarly, whenever the hostess or manager pages pager #99, all queue status query stations receive the page and update their internal clock by increasing the clock by 5 minutes. This has the effect of showing 5 minute decreased wait times. The page sender system described here is an example of a delay status transmitter. This method should only be used if the time clocks are not used to report actual time of day. A pager system delay status transmitter and delay status receiver system such as described here may also be used if the clocks are used to report actual time of day, but then the queue status query stations need to maintain and use an independent time adjustment datum that is incremented and decremented as pages to the delay status receivers are received.

In another embodiment of the present invention, the queue status query station may also display messages such as funny sayings or fortunes to the guest along with pertinent wait queue data to help raise the spirits of the guest. These messages are examples of non-status information that may be displayed for a guest. The nature of the message may be programmed to depend upon the amount of time remaining until seating, or the amount of time that seating is past due.

In another embodiment of the present invention, an RFID reader device that is part of an identification tag dispenser may be used to trigger input of the pager identification number into a personal computer or other service request management processor. In the most preferred embodiments, the pager identification number is recorded on an RFID tag affixed to each pager. The input into a personal computer or another wait list management system is triggered when the pager with the RFID tag is brought into proximity of the identification tag dispenser RFID reader device, for example by a greeter when the greeter presents the pager to a guest party. The input to the system is a pager number that the system may use or reference to identify a certain guest party. This automatic entry eliminates the need for the greeter to manually type in a pager number to the system. The input trigger may also prompt the system to ask various questions to the greeter about the guest party that will be receiving the pager, such as the number in the party, a smoking preference, etc.

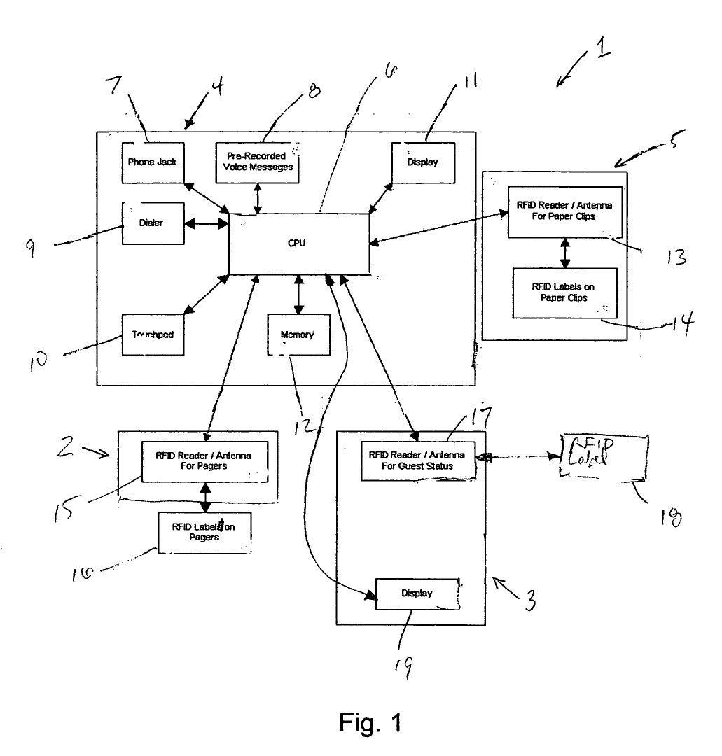

Referring now to FIG. 1, a preferred embodiment of a tracking system 1 is portrayed. Tracking system 1 includes integrator 4, pager docking area 2 for reading RFID labels on stored pagers, guest status pad 3 for reading RFID labels that are on the issued pagers and reporting the current wait status of those pagers, and paper clip docking area 5 for reading RFID labels on stored on issued paper clips and reporting the current wait status those paper clips. Integrator 4 is an example of a service request management processor. Pager docking area 2 and paper clip docking area 5 are examples of an identification tag dispenser. Guest status pad 3 is an example of a queue status query station.

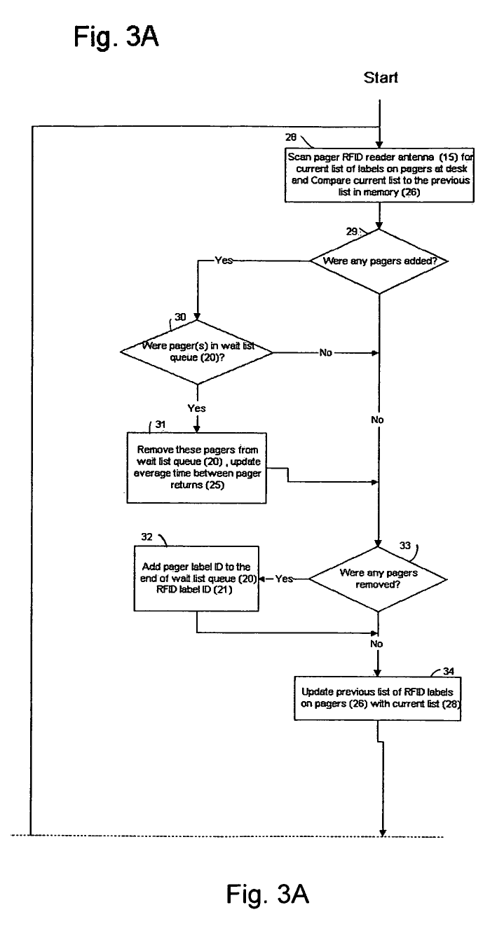

As shown symbolically by the double-ended arrows, CPU 6 manages and integrates with RFID reader and antenna 15 in pager docking area 2, with RFID reader and antenna 17 in guest status pad 3, and with RFID reader and antenna 13 in paper clip docking area 5. CPU 6 also integrates with guest status display 19, integrator display 11, memory 12, touchpad 10, dialer 9, pre-recorded voice messages 8, and phone jack 7. In addition, CPU 6 runs software that mimics the flow of FIG. 3.

Phone jack 7 connects to phone line and telecommunications occurs when CPU 6 uses dialer 9 to initiate and dial a phone number. After a phone number is dialed, a pre-recorded voice message 8 is played.

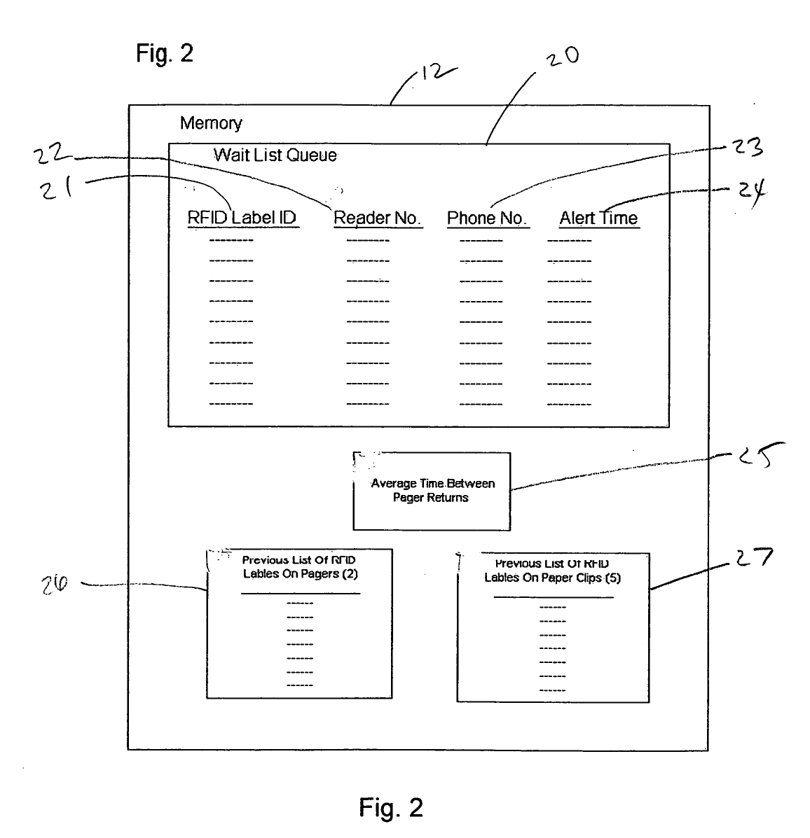

Memory 12 is shown in depth in FIG. 2. Memory 12 is used to store wait list queue information, past RFID label inventories at RFID reader and antenna 15 and RFID reader and antenna 13 as well as an average value for time between queue advances.

Display 11 keeps the attendant informed of total current wait list time and displays any questions the system may need to ask the attendant

Touchpad 10 allows the attendant to interact with the system when the system prompts the attendant for answers on the display 11.

RFID reader and antenna 13 and RFID reader and antenna 15 are controlled by the CPU 6 and they continuously poll all RFID labels (14 and 16, respectively) that are in the range of their antenna and report the identification of those RFID labels back to the CPU 6, which maintains an inventory of available RFID labels in memory 12.

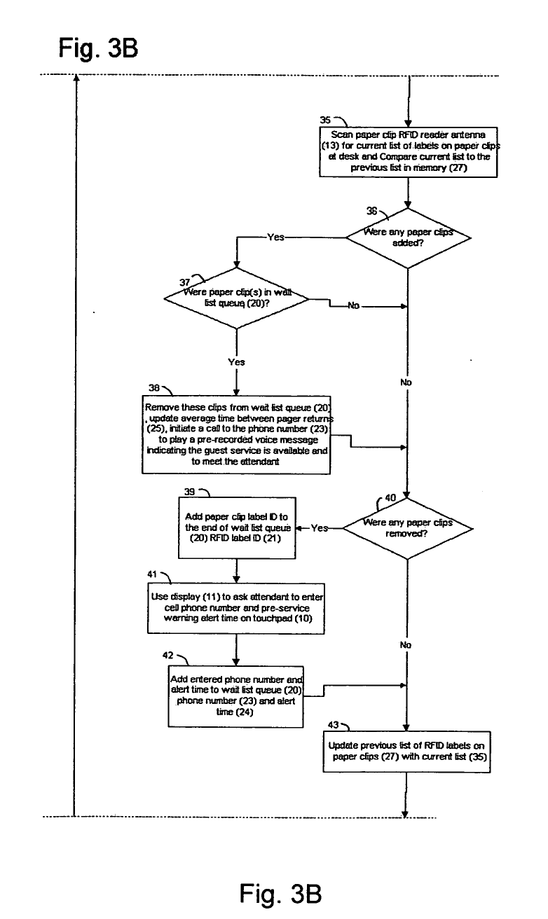

RFID label 16 may be a passive or an active label. Passive labels include no power source and are activated by the antenna 15. Active labels contain a battery for power source. RFID label 16 responds with its ID and any other data stored on it when requested by the antenna 15. RFID label 16 is affixed to or built into a guest pager (not shown in FIG. 1). FIG. 4 illustrates how RFID label 16 may affixed to a guest pager 50.

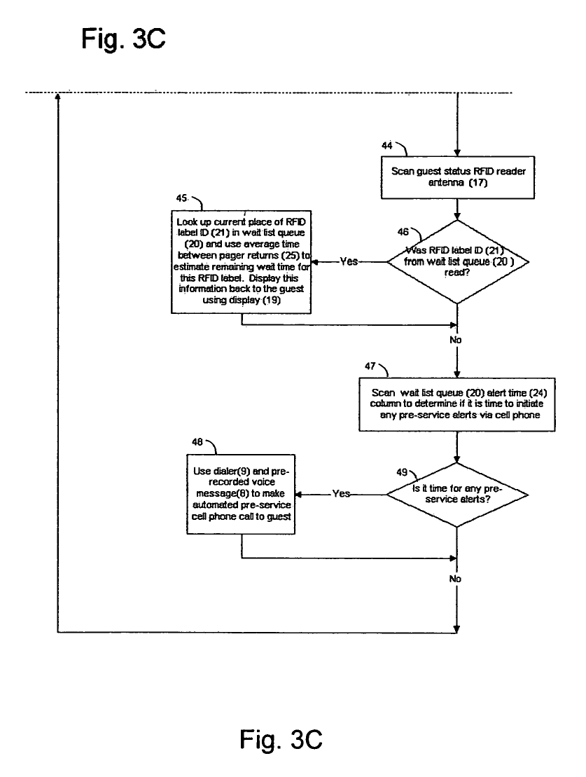

As previously indicated, tracking system 1 includes a paper clip docking area 5. FIG. 5 illustrates how an RFID label 14 is affixed to a paper clip 51. Paper clip 51 is an example of a “token.” RFID label 14 is small and is sometimes referred to as a button tag. The primary purpose of a token (such as paper clip 51) is to act as a physical carrier for RFID label 14 so that RFID label 14 is not lost. RFID label 14 may be a passive or an active label. RFID labels on paper clips 14 respond with their ID and any other data stored on them when requested by the antenna 13. RFID labels 14 are affixed to or built into the paper clip. FIG. 5 illustrates how RFID label 14 may be affixed to paper clip 51.

RFID reader and antenna 17 on guest status pad 3 is controlled by the CPU 6 which continuously polls for any RFID label 18 that may be in range of RFID reader and antenna 17. RFID label 18 may be affixed to a pager or to a paper clip. If there is an RFID label 18 in range, the CPU 6 writes the current place in wait list queue and current time left to wait on the display 19 on guest status pad 3. If there is no RFID label 18 in range, the CPU 6 writes the current estimated wait time on the display 19. RFID label 18 may be a passive or an active label. RFID label 18 responds with its ID and any other data stored on it when requested by the antenna 17. RFID label 18 is affixed to or built into the guest pager or a paper clip (not shown in FIG. 1). RFID labels 14, 16 and 18 are examples of identification tags.

Certain contents of memory 12 are shown in more detail in FIG. 2. Wait list queue 20 is a table made up of four columns. As rows are added to the wait list queue 20, they are added to the end. The four columns of the table are RFID Label ID 21, Reader Number 22, Phone Number 23, and Alert Time 24.

When a row is added to wait list queue, the ID from the RFID label which prompted the row addition will be stored in the RFID Label ID 21 column. The RFID reader and antenna that prompted the row addition will be stored in the Reader Number 22 column. If the RFID label that was removed was attached to a paper clip 14, the attendant is prompted to type in a phone number and alert time by the integrator 4 of FIG. 1. The answers to the prompts are stored in the Phone Number 23 column and the Alert Time 24 column.

Average value for time between queue advances or pager returns 25 is stored in memory 12. As the queue advances this time 25 is updated taking into account the latest time between queue advances.

Previous list of read RFID labels affixed to pagers 26 is stored in memory 12 to be compared with the most current list of read RFID labels. This comparison will allow the system to know when labels are removed or put back to their location.

Previous list of read RFID labels affixed to paper clips 27 is stored in memory 12 to be compared with the most current list of read RFID labels. This comparison will allow the system to know when labels are removed or put back to their location.

Turning now to FIGS. 3A, 3B, and 3C, the method of the current invention is illustrated in more detail beginning at the top of FIG. 3A. In step 28, the system scans the RFID reader antenna 15 for a current list of all RFID labels that are affixed to pagers 16 that are in the range of the RFID reader and antenna 15. The system also compares the results of this scan to the previous list of pager RFIDs 26 that is stored in memory 12 as depicted in FIG. 2.

In steps 29-33 these results are analyzed. If there are pagers found to be added by the comparison and those pagers were in the wait list queue 20, then those row(s) in the wait list queue 20 are removed and the average time between queue advances 25 is updated appropriately. If there are pagers found to be removed by the comparison in step 28, a row is added to the wait list queue 20 with the RFID label ID 21 set to the ID of the label(s) that were detected as removed. The Reader Number 22 column in the new row is also inserted with a designator of the antenna 15 by which the detection was sensed.

In step 34, the previous list of pager RFID's 26 (FIG. 2) is replaced with the new list that was determined in step 28.

In step 35, the system scans the RFID reader antenna 13 for a current list of all RFID labels that are affixed to paper clips 14 that are in the range of the antenna 13. The system also compares the results of this scan to the previous list of paper clip RFID's 27 that is stored in memory 12 (FIG. 2).

In steps 36-42 these results are analyzed. If there are paper clips found to be added by the comparison and those paper clips were in the wait list queue 20, then those row(s) in the wait list queue 20 are removed, and if service intake intervals are short, the signaling device associated with the next party in the queue may be is signaled to indicate that service is available. If the signaling device associated with the next party in the queue is a cell phone, the phone number 23 is dialed by the dialer 9 and a pre-recorded voice message 8 is played. This message may contain this type of language, “Your table is now ready, please come to the greeter desk to be seated.” The average time between queue advances 25 is also updated appropriately.

If there are paper clips found to be removed by the comparison in step 35, a row is added to the wait list queue 20 with the RFID label ID 21 set to the ID of the label(s) that were detected as removed. The system then prompts the attendant via the display 11 to enter the cell phone number and the pre-service warning alert time on the touchpad 10. The answers to these prompts are inserted into the new row in the queue 20 under the Phone Number 23 and Alert Time 24 columns respectively. The Reader Number 22 column in the new row is also inserted with a designator of the antenna 13 by which the detection was sensed.

In step 33, the previous list of RFID labels affixed to paper clips 27 is replaced with the new list that was determined in step 35.

In step 44, the system scans the RFID reader antenna 17 for any RFID label 18 that are in the range of the antenna 17.

In steps 45-46, the these results are analyzed. If there was found to be an RFID label 18 in the range of the antenna 17, the appropriate row in the wait list queue 20 is looked up that matches the RFID label ID 21 with the label being sensed. Using the average time between returns 25, the current place in wait list queue 20 and estimated current wait time are reported back to the display 19.

In step 47, the wait list queue 20 Alert Time 24 column is scanned to determine if any alert calls should be made at the present time.

In steps 48-49, the results are analyzed. If any row has an Alert Time 24 that is less than or equal to its current wait time, then the dialer 9 and pre-recorded voice message 8 is used to call the Phone Number 23 to give pre-service alert. This message may contain this type of language, “Your table will be ready in approximately 15 minutes.”

Next, the system will start over and begin executing at step 28 again.

In some embodiments of this invention, technically-advanced pagers with annunciating capabilities are used, and steps similar to steps 41 and 42 for paper clip RFID labels are added after step 32 in FIG. 3A for pager RFID labels, such that an electronic text, audio, or video message is triggered on the pager to provide a pre-service alert.

FIG. 4 illustrates a typical guest pager as you would see in some restaurants, churches or doctor's offices. In this figure there has been an RFID label affixed to the underside of the pager 16. This label could also be contained within the pager.

FIG. 5 illustrates a regular plastic paper clip that has a “button” RFID label attached to it. This RFID label could also be embedded inside the paper clip 14. This paper clip is used to mark the place on a paper wait list of a guest who is using their cell phone as a pager instead of a pager like in FIG. 4. Instead of writing down the number on the pager, as is typically done, the paper clip is used to mark that spot.

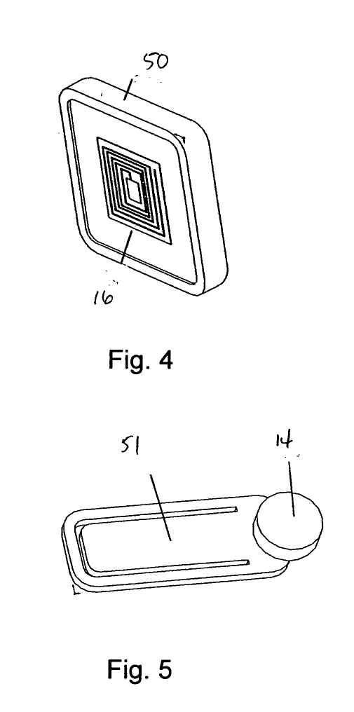

FIG. 6 illustrates the integrator unit 1 that operates will all RFID readers and antennas 15,17,13 as well as prompts the attendant on the display to enter phone numbers and other questions. The integrator contains a section that houses the paper clips in FIG. 5. The integrator 1 senses when a paper clip is removed from the antenna 13 range which prompts various questions on the display 11.

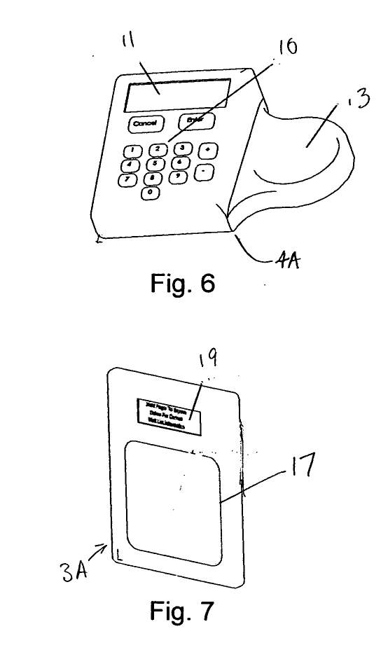

FIG. 7 illustrates the guest status pad 3 which includes the display 19 and the RFID reader and antenna 17. As an RFID label that is affixed to a pager 16 is within range of the antenna 17, the display 19 with show current wait list queue 20 status that included current place in queue and current estimated wait time. It is important that the RFID reader and antenna used for the guest status pad be sufficiently physically distant from any RFID reader and antenna used to monitor removal and return of RFID labels so that the system does not interpret the presence of an RFID label at the guest status pad to represent the return of an RFID label. The range of the RFID reader and antenna is typically less than one foot, so a separation of the guest status pad and antenna from the RFID label storage area(s) and antenna(s) by at least two feet is generally sufficient.

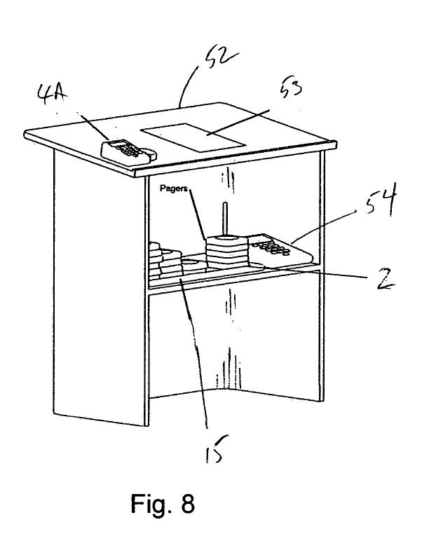

FIG. 8 illustrates a perspective view from the back of one embodiment of the system. A service request management processor, integrator 4A, is positioned on a console 52. An identification tag dispenser, pager docking area 2, is interfaced to the integrator 4A. An alerting system, paging system 54, is provided to page guests using a pager as the signaling device. The paging system 54 sends an alerting signal (a page) to the pager. The pager produces a notification signal (e.g., a buzzer tone, a flashing light, or a physical vibration) to alert the guest user that a table is ready or that some other change in the service queue has occurred. The integrator 4A has a built-in phone dialer that is used as the alerting system for guests using a cell phone as the signaling device. The phone dialer sends an alerting signal (e.g., a phone call with a recorded message) to the cell phone which produces a notification signal (e.g., a ring tone and the recorded message) to alert the guest user that a table is ready or that some other change in the service queue has occurred. A monitor 53 that is interfaced to the integrator 4A displays the contents of the wait list queue 20 that is stored in memory 12 of integrator 4A.

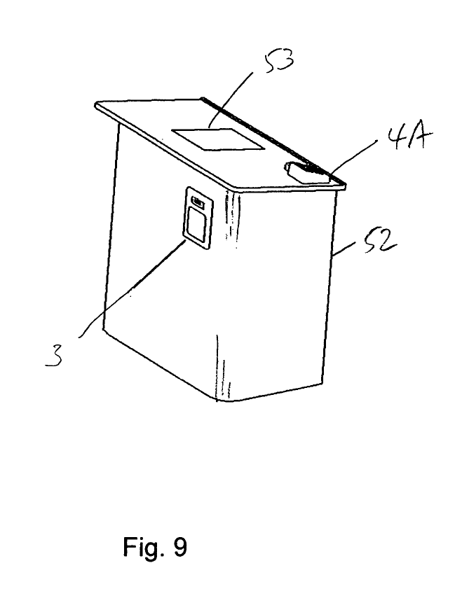

FIG. 9 illustrates the same systems as in FIG. 8 viewed from the front, showing how the guest status pad 3 may be mounted to the front of the attendant desk.

Accordingly, the present invention provides a system and method of managing a wait list queue by such mechanisms as giving automated wait list updates to inquiring guests and automatically notifying guests at a designated amount of time prior to services being available for them. Other implementations may automatically notify guests about services being available for them immediately via phone call notification initiated by such mechanisms as RFID paper clip tracking. Various implementations may also provide mechanisms to reduce the amount of time spent in manually determining total wait list times and current wait list times for waiting guests. Some embodiments provide an automated method of inputting a pager identification number to an existing wait list management system. An automated method may be provided for prompting an existing wait list management system that action or information needs to be input into it. In some applications a humorous response is provided with the queue status query station when used by the guest to raise spirits of the guest or a marketing message may be provided to raise spirits of the guest, e.g., “2 for 1 margaritas are currently being offered at the bar.”

Some embodiments incorporate equipment to report a progress event. Examples of a progress event are completion of an event such as seating a party, and receipt of a job order by a maintenance worker. In implementations where the completion of an event occurs at a location remote from the service request management processor, separate communication devices, such as a one way alpha pagers, may be used to indicate that a message was actually received by the recipient or group of recipients. For example, this system could be used in a hospital setting in which many queue status query stations on each floor of the hospital or clinic wirelessly communicate to a main service request management processor. As hospital staff members are broadcast paged with a text message, e.g.: “patient in room 301 needs assistance.” A staff member may acknowledge the receipt of the message by passing the pager which has an RFID tag affixed to it or embedded inside it over a queue status query station (in this system it is actually an acknowledgement pad). Such acknowledgement of receipt of message is an example of completion of a queued event. The queue status query station then wirelessly notifies the service request management processor of the acknowledgement and the service request management processor may send out another broadcast message to staff members that the problem has been resolved. Some embodiments may not utilize wait queue features described elsewhere; instead the queue status query station may only be used as an “acknowledgement” station.

To summarize a most-preferred embodiment, a queue and wait list management system is provided that automatically creates a queue and calculates current estimated wait time and tracks current place in queue. The system also initiates events based upon queue changes. The system includes a radio frequency identification (RFID) label reader and antenna (identification tag dispenser), RFID labels (identification tags) attached to items (signaling devices) that establish a place in queue (such as an electronic guest pager), a central processing unit (CPU) (service request management processor) that calculates queue changes and initiates events, and preferable one or more additional RFID readers and antenna (queue status query stations) that are used to provide current queue status and wait time information to RFID labels that are within that antenna range. The CPU works in conjunction with the RFID reader to read and record all RFID labels currently in the range of the antenna. The CPU repeats this process continuously and compares the latest RFID label information with the previous RFID label information to determine which labels have been added or removed. This information is then used to adjust the queue of outstanding RFID labels as well as calculate average wait time between labels being returned and total wait time of all outstanding labels. As RFID labels are removed, they are added to the end of an electronic queue that is managed by the CPU. As RFID labels are returned, the queue is updated with the new set of outstanding labels. It is assumed that the order in which the RFID labels are removed is the same order in which the RFID labels are returned. At any point in time any outstanding label can be placed in range of the second RFID reader and antenna to get a current status update including current wait time or place in queue. The system may also initiate events based on a change in the service request queue. For example, the system may dial a personal cell phone number and play a recorded message when a certain RFID label gets bumped to, say, 5th in the queue.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A system for tracking a service request queue, the system comprising:
an identification tag for issuance to a user;
an identification tag writing station for recording queue information on the identification tag;
a queue status query station having (a) an identification tag reader for reading the queue information on the identification tag and (b) a display for displaying queue status information corresponding to the queue information, whereby when the identification tag is presented to the queue status query station the queue information is read and the queue status information is displayed;
an alerting system for generating an alert signal to indicate a change in the service request queue; and
a signaling device associated with the identification tag, the signaling device being responsive to the alert signal to generate a notification signal for notifying the user of a change in the service request queue.

2. The system of claim 1 wherein the queue status query station includes a delay status receiver, and the system further comprises a delay status transmitter whereby the queue status query station is notified of a change in the service request queue wait time.

3. The system of claim 1 wherein the signaling device is a pager.

4. The system of claim 1 wherein the signaling device is a cell phone.

5. The system of claim 1 further comprising an identification tag dispenser that prompts input of information into the identification tag writing station when an identification tag is issued to a user.

6. The system of claim 1 wherein the queue status query station further contains non-status information, at least a portion of which is displayed when the queue information is read.

7. The system of claim 1 further comprising an identification tag progress station whereby the identification tag is read and a progress event is reported.

8. A system for tracking a service request queue, the system comprising:
an identification tag having a stored identification number, for issuance to a user;
a service request management processor for maintaining queue information associated with the identification number;
a queue status query station having (a) an identification tag reader for reading the identification number of the identification tag, (b) a communication link with the service management processor for communicating queue information associated with the identification number, and (c) a display for displaying queue status information corresponding to the queue information associated with the identification number, whereby when the identification tag is presented to the queue status query station, queue status information is displayed;
an alerting system for generating an alert signal to indicate a change in the service request queue; and
a signaling device associated with the identification tag, the signaling device being responsive to the alert signal to generate a notification signal for notifying the user of a change in the service request queue.

9. The system of claim 8 wherein the signaling device is a pager.

10. The system of claim 8 wherein the signaling device is a cell phone.

11. The system of claim 8 further comprising an identification tag dispenser that prompts input of information into the service request management processor when an identification tag is issued to a user.

12. The system of claim 8 wherein the queue status query station further contains non-status information at least a portion of which is displayed when the queue information is read.

13. The system of claim 8 further comprising an identification tag progress station where the identification tag is read a progress event is reported.

14. A method of tracking a service request queue, the method comprising:
associating a signaling device with an identification tag;
issuing the identification tag to a user;
displaying queue status information when the identification tag is presented to a queue status query station;
notifying the user of a change in the service request queue using the signaling device.

15. The method of claim 14 further comprising the step of prompting the input of information when the identification tag is issued.

16. The method of claim 14 wherein the step of associating a signaling device with the identification tag comprises associating a pager with the identification tag and the step of notifying the user of a change in the service request queue using the signaling device comprises notifying the user of a change in the service request queue by signaling the pager.

17. The method of claim 14 wherein the step of associating a signaling device with the identification tag comprises associating a cell phone with the identification tag and the step of notifying the user of a change in the service request queue using the signaling device comprises notifying the user of a change in the service request queue by calling the cell phone.

18. The method of claim 14 further comprising presenting non-status information when the identification tag is presented to a query station;

19. The method of claim 14 further comprising reporting a progress event when the identification tag is presented to an identification tag progress station.

20. The method of claim 14 further comprising reporting the completion of a queued event when the identification tag is presented to an identification tag progress station.
